(19) United States
(12) Patent Application Publication
(10) Pub. No.: US 2012/0114998 A1
(43) Pub. Date: May 10, 2012

(54) WATERPROOF BATTERY CASE

(76) Inventor: Steve Han Shi HWANG, Chungho City (TW)

(21) Appl. No.: 13/033,528

(22) Filed: Feb. 23, 2011

(30) Foreign Application Priority Data
Nov. 8, 2010 (TW) 099221558

(51) Int. Cl. H01M 2/10

(52) U.S. Cl. 429/99

(57) ABSTRACT

The present invention relates to a waterproof battery case, consists of a case member, an electrode plate set and a sealing connector. Connection surfaces of a base and a top cover of the case member are oppositely installed with a flange and a concave slot, and a resilient sealing unit is embedded in the concave slot; the interior of the base is installed formed with two opposite inner walls for the installation of battery; the electrode plate set is fastened on the inner ends of the two opposite inner walls according to the circuit layout, and wires connected to positive and negative joints extend to a wall hole pre-formed on the base; the sealing connector has a tubular main body allowing the wires to penetrate, a second connection part of the main body is sleeved with a resilient sealing pad then inserted in the wall hole, and further fastened with a fastening unit, the exterior of a first connection part of the main body is formed with at least two arc-shaped clipping sheets arranged in an annular state, a resilient binding ring is sleeved in the arc-shaped clipping sheets, and a tightening unit is fastened with the first connection part, such that the radial inner wall of the tightening unit presses the arc-shaped clipping sheets so as to bind the wires through the binding ring. The present invention provides an effect of multiple sealing, such that liquid, moisture or dust are effectively prevented from entering the case member.

### BACKGROUND OF THE INVENTION

1. Field of the Invention

The present invention relates to a battery case, especially to a waterproof battery case having waterproof and dustproof effects.

2. Description of Related Art

Dry batteries have been developed for a long time, which are used to save power in column-shaped members for necessary usage. So we can use electronic devices more conveniently and the limitation of conventional batteries is broken through, and more convenience is provided to our lives.

As a result, a device for accommodating batteries is developed, and the accommodation and storage of battery is sometimes combined within an electronic device as one piece, such as a toy, palmtop radio, and flashlight. And there is also a separation type. Moreover, there is another application which is a battery case for recharging battery, i.e. after rechargeable batteries are placed in, the AC power is supplied and is rectified and lowered the voltage, such that the rechargeable batteries can be processed with the recharge operation in the battery case.

One feature of these battery cases is that most circuit is in series type, of course for some special needs, a parallel type circuit can be adopted in a battery case. However, in actual use, a battery case may be used in outdoor or moist environments, so the waterproof issue shall be seriously concerned.

A conventional sealed type battery case has been developed, for example the “Sealed battery case” disclosed in the Taiwan Utility Model No. 257390 or No. 478656; the sealed battery case includes a case seat and a case cover engaged with the case seat, and the interior of the case seat is installed with positive and negative electrode plates, the engagement of the case seat and the case cover is in a sliding state, and a wall hole is formed on the wall surface of the case seat so wires can protrude to exterior. Even though the battery case belongs to the sealed type, liquid and moisture can still penetrate into the case seat through slits generated between the case seat and the case cover and through the wall hole, therefore short circuit is occurred, and the positive and negative electrode plates are eroded. The mentioned sealed battery case is not able to be used in outdoor or moist environments and shall be improved.

### SUMMARY OF THE INVENTION

One primary object of the present invention is to provide a waterproof battery case. In the battery case, special sealing structures are installed at connection areas of a base and a top cover, a case member and a sealing connector, and the sealing connector and wires, such that liquid and moisture or even dust are prevented from entering the case member, and the normal DC power supply is therefore ensured, and the waterproof battery case is suitable to be used in outdoor or moist environments.

For achieving the mentioned object, the present invention provides a waterproof battery case, comprises:

a case member, composed of a base and a top cover being installed at the top of the base, connection surfaces of the base and the top cover are oppositely installed with a flange and a concave slot, and a resilient sealing unit is embedded in the concave slot; an accommodation space is formed in the base, the accommodation space is installed with two opposite inner walls for the installation of battery, wherein one of the inner walls is formed with two wire slots communicating with the accommodation space, and a through wall hole is formed at a proper location of the case member and the accommodation space;

an electrode plate set, consists of at least one positive joint and at least one negative joint, the positive and negative joints are respectively fasted on the inner surfaces of the two opposite inner walls with respect to the circuit layout, and wires connected to the positive and negative joints protrude the wire slots and extend to the wall hole; and

a sealing connector, installed with a tubular main body allowing the wires to penetrate, two sides of the main body are respectively formed with a first and a second connection parts, the second connection part is sleeved with a resilient sealing pad then is inserted in the wall hole, and is further fastened with a fastening unit; the outer end of the first connection part is integrally extended with at least two arc-shaped clipping sheets arranged in an annular state, a resilient binding ring allowing the wires to pass through is sleeved in the arc-shaped clipping sheets, and a tightening unit allowing the wires to protrude is fastened with the first connection part, such that the inner radial wall of the tightening unit presses the arc-shaped clipping sheets so as to bind the wires through the binding ring.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded perspective view illustrating the waterproof battery case according to the first embodiment of the present invention;

FIG. 2 is a perspective view illustrating the assembly of the waterproof battery case of FIG. 1;

FIG. 3 is a cross sectional view taken along line A-A of FIG. 2;

FIG. 4 is an exploded perspective view illustrating the waterproof battery case according to the second embodiment of the present invention.

### DETAILED DESCRIPTION OF THE PREFERRED EMBODIMENT

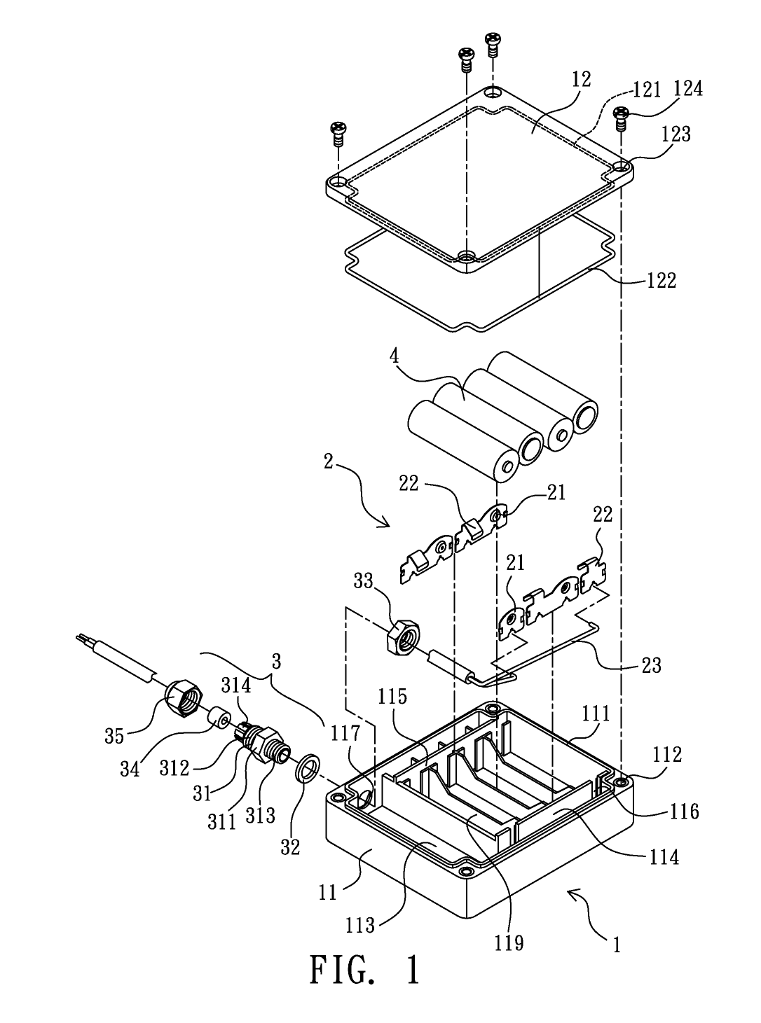

As shown from FIG. 1 to FIG. 3, the waterproof battery case according to the present invention comprises a case member 1, an electrode plate set 2 and a sealing connector 3.

The case member 1 is composed of a base 11 and a top cover 12 being installed at the top surface of the base 11. As shown in FIG. 1, for providing a sealing effect between the base 11 and the top cover 12, opposite surfaces thereof are respectively installed with a flange 111 and a concave slot 121. An elongated or circular resilient sealing unit 122 is embedded in the concave slot 121. As such, when the base 11 is engaged with the top cover 12, the sealing unit 122 installed in the concave slot 121 is abutted and pressed by the flange 111 so a liquid sealing effect is obtained, and liquid, moisture and dust are effectively prevented from entering the case member 1. As shown in FIG. 1, the flange 111 and the concave slot 121 are respectively installed on the top surface of the base 11 and the bottom surface of the top cover 12, but the arrangement is not limited to the abovementioned, i.e. the flange and the concave slot can be respectively installed on the bottom surface of the top cover 12 and the top surface of the base 11, and the resilient sealing unit 122 can also be embedded in the concave slot installed on the top surface of the base 11 so the same liquid sealing effect is obtained.

Referring to FIG. 1, the combination method of the base 11 and the top cover 12 is that four corners of the connection surfaces thereof are oppositely installed with screw holes 112 and through holes 123, such that conventional connection members 124, e.g. screws, can pass through the through holes 123 and be fastened with the screw holes 112. The combination method is not limited to the abovementioned, other combination methods such as the connection surfaces of the base 11 and the top cover 12 being oppositely installed with buckling hooks and buckling slots so a buckling means is achieved, or connection surfaces of the round base 11 and the top cover 12 being oppositely installed with threads for being combined with a screw engagement means are within the scope of the present invention.

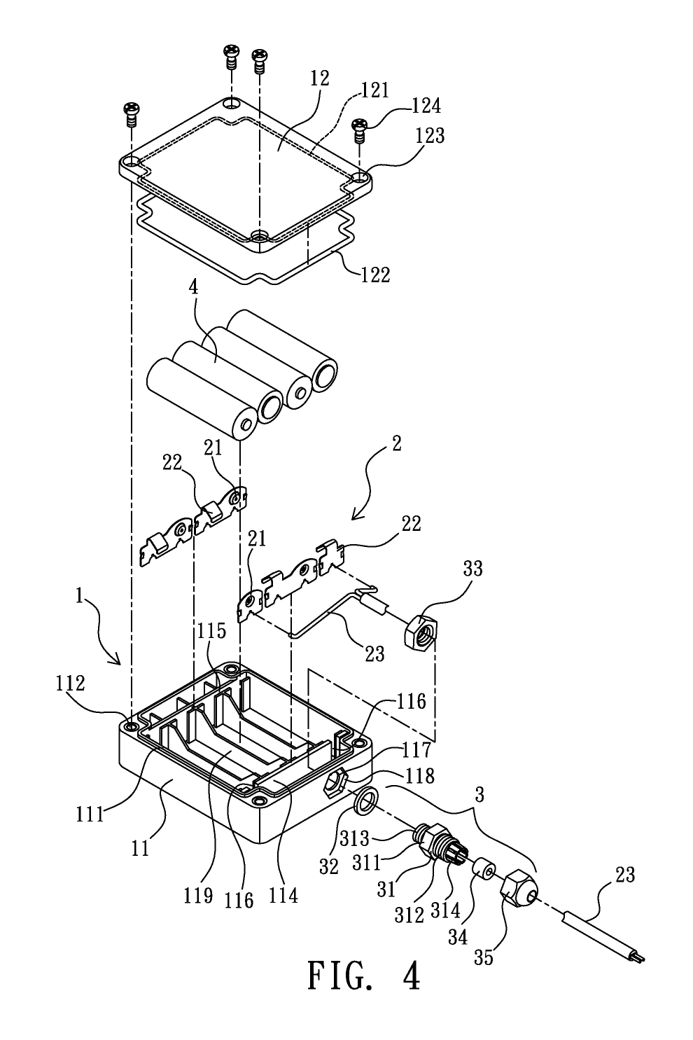

The interior of the base 11 is formed with an accommodation space 113 having two opposite inner walls 114 for receiving batteries 4. Inner ends of the inner walls 114 are respectively installed with an insertion slot 115 for allowing the electrode plate set 2 to be inserted and positioned. One of the inner walls 114 is installed with two wire slots 116 communicating with the accommodation space 113 for allowing wires 23 welded at positive and negative joints 21, 22 to protrude, and the wires 23 are extended to a through wall hole 117 installed at a proper location of the case member 1 and the accommodation space 113, the outer surface of the wall hole 117 is connected with a positioning slot 118, which is larger in size and in a non-circular shape, e.g. hexangular (referring to FIG. 4 due to the projection angle). For partitioning two adjacent batteries 4, at least one partition rib 119 having the size corresponding to the battery 4 is vertically installed on the two opposite inner walls 114.

The electrode plate set 2 consists of at least one positive joint 21 and at least one negative joint 22. As shown in FIG. 1, the base 11 of the waterproof battery case can accommodate four batteries, but the abovementioned is not served as a limitation, the quantity of battery in the battery case can be less or more than four according to the actual needs of power supply. For obtaining an electronic connection is series, the negative joints 22 and the positive joints 21 in the inner end of each inner wall 114 are arranged with a staggering means, then the adjacent positive joint 21 and the negative joint 22 on the inner wall 114 are electrically connected, and the positive joint 21 and the negative joint 22 on the other inner wall 114 are respectively connected with a wire 23 which is protruded from the wire slot 116 of the inner wall 114 and extended to the wall hole 117; the arrangement of the electrode plate set 2 is a conventional arrangement, and the arrangement of positive and negative joints and electrical connection in series or in parallel are not limited to the disclosure according to the present invention, the required arrangements are according to actual needs.

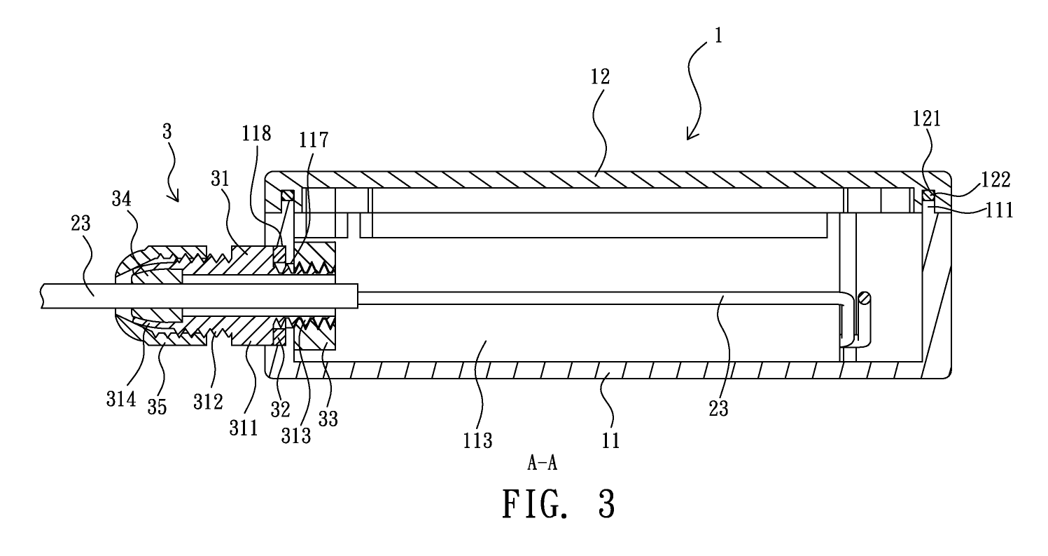

As shown in FIG. 1 and FIG. 3, the sealing connector 3 has a tubular main body 31 allowing the mentioned wires 23 to penetrate. The main body 31 is radially and protrudingly installed with a positioning column 311 having the same size and shape as the positioning slot 118, so the positioning column 311 can be inserted and positioned in the positioning slot 118. The left and right sides of the positioning column 311 are respectively formed with a first and a second connection parts 312, 313, as shown in figures, the first and the second connection parts 312, 313 are thread parts in actual use. The second connection part 313 is sleeved with a resilient sealing pad 32 then inserted in the wall hole 117, such that the positioning column 311 is installed in the positioning slot 118 and rotation is prevented; then a fastening unit 33, e.g. a fastening screw nut, is screwed and fastened with the second connection part 313 which is inserted in the wall hole 117, so the wall hole 117 is provided with a liquid sealing effect and the main body 31 is enabled to protrude from the surface of the case member 1.

The right side of the first connection part 312 is integrally extended with at least two arc-shaped clipping sheets 314 arranged in an annular state, a resilient binding ring 34 is sleeved in the at least two arc-shaped clipping sheets 314, after the wires 23 pass through the binding ring 34, a tightening unit 35, e.g. a tightening screw nut, is screwed and fastened with the first connection part 312, such that the inner radial wall of the tightening screw nut 35 presses the at lease two arc-shaped clipping sheets 314 so as to bind the wires 23 through the binding ring 34, thus a liquid sealing effect is formed and the wires 23 protrude to the exterior of the sealing connector 3 for being connected with an electronic device.

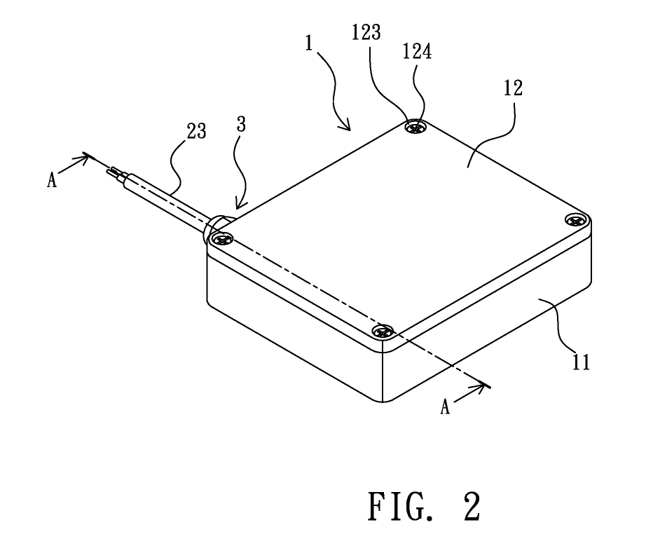

As shown in FIG. 2 and FIG. 3, which are perspective views showing the assembly of the present invention, through the multiple sealing effects of the sealing unit 122 between the top cover 12 and the base 11, the sealing pad 32 between the wall hole 117 and the tubular main body 31, and the binding ring 34 between the at least two arc-shaped clipping sheets 314 and the wires 23, liquid, moisture and dust are effectively prevented from entering the case member 1, so the normal power supply is ensured, and the electrode plate set 2 is prevented from eroded, and the waterproof battery case of the present invention is suitably to be used in outdoor or moist environments.

Referring to FIG. 4, which is an exploded perspective view showing the waterproof battery case according to the second embodiment of the present invention, the difference from the mentioned embodiment is the arrangement direction of the two opposite inner walls 114 and the electrode plate set 2, so the installing locations of the two wire slots 16 are changed, for not only shortening the lengths of the wires 23 inside the case member 1, but also changing the installing directions of the wall hole 117, the positioning slot 118 and the sealing connector 3 inside the case member 1, for being able to corresponding to clients' actual needs.

As such, the advantages of the present invention are that: through installing resilient sealing components between the base and the top cover, the case member and the main body, and the main body and the wires, liquid, moisture and dust are prevented from entering the case member for ensuring the DC power supply, and the electrode plate set is prevented from being eroded, so the service life of the battery case is prolonged, and the waterproof battery case is fully qualified to be used in outdoor or moist environments.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A waterproof battery case, comprising:
a case member, consisting of a base and a top cover being installed at the top of the base, connection surfaces of the base and the top cover being oppositely installed with a flange and a concave slot, and a resilient sealing unit being embedded in the concave slot; an accommodation space being formed in the base, the accommodation space being installed with two opposite inner walls for the installation of battery, wherein one of the inner walls being formed with two wire slots communicating with the accommodation space, and a through wall hole being formed at a proper location of the case member and the accommodation space;
an electrode plate set, consisting of at least one positive joint and at least one negative joint, the positive and negative joints being respectively fasted on the inner surfaces of the two opposite inner walls with respect to the circuit layout, and wires connected to the positive and negative joints protruding the wire slots and extending to the wall hole; and
a sealing connector, installed with a tubular main body allowing the wires to penetrate, parts, two sides of the main body being respectively formed with a first and a second connection parts, the second connection part being sleeved with a resilient sealing pad then being inserted in the wall hole, and further fastened with a fastening unit; the outer end of the first connection part being integrally extended with at least two arc-shaped clipping sheets arranged in an annular state, a resilient binding ring allowing the wires to pass through being sleeved in the arc-shaped clipping sheets, and a tightening unit allowing the wires to protrude being fastened with the first connection part, such that the inner radial wall of the tightening unit pressing the arc-shaped clipping sheets so as to bind the wires through the binding ring.

2. The waterproof battery case according to claim 1, wherein the outer surface of the wall hole is connected with a positioning slot, which is larger in size and in a non-circular shape; a positioning column, having the same size and shape as the positioning slot, is radially and protrudingly installed between the first and the second connection parts of the main body, and the positioning column is inserted and positioned in the positioning slot.

3. The waterproof battery case according to claim 1, wherein the first and the second connection parts are thread parts, and the fastening unit and the tightening unit are a fastening screw nut and a tightening screw nut.

4. The waterproof battery case according to claim 1, wherein at least one partition rib is vertically installed on the two opposite walls with respect to the battery size, for partitioning two adjacent batteries.

5. The waterproof battery case according to claim 1, wherein the flange and the concave slot are respectively installed on the top surface of the base and the bottom surface of the top cover.

6. The waterproof battery case according to claim 1, wherein the flange and the concave slot are respectively installed on the bottom surface of the top cover and the top surface of the base.

7. The waterproof battery case according to claim 1, wherein four corners of the connection surfaces of the base and the top cover are oppositely installed with screw holes and through holes, and screws are provided for passing through the through holes and being fastened with the screw holes.

8. The waterproof battery case according to claim 1, wherein the connection surfaces of the base and the top cover are respectively installed with buckling hooks and buckling slots, such that the combination is processed with a buckling means.

9. The waterproof battery case according to claim 1, wherein the connection surfaces of the base and the top cover are respectively formed with thread, such that the combination is processed with a screwing means.

10. The waterproof battery case according to claim 1, wherein the inner ends of the two opposite inner walls are respectively installed with an insertion slot for allowing the positive and negative joints of the electrode plate set to be inserted and positioned.
